(19) United States
(12) Patent Application Publication
(10) Pub. No.: US 2026/0352928 A1
(43) Pub. Date: Nov. 5, 2026

(54) TRANSITION POSITION DETERMINATION METHOD AND APPARATUS, AND MEDIUM AND ELECTRONIC DEVICE

(71) Applicant: Beijing Zitiao Network Technology Co., Ltd., Haidian District, Beijing (CN)

(72) Inventors: Sen PEI, Beijing (CN); Jingya YU, Beijing (CN); Wozhou HE, Beijing (CN); Qi CHEN, Beijing (CN)

(21) Appl. No.: 19/484,112

(22) PCT Filed: May 14, 2024
(86) PCT No.: PCT/CN2024/092966

§ 371 Date: Nov. 13, 2025

(30) Foreign Application Priority Data
May 16, 2023 (CN) 202310553345.9

(51) Int. Cl. H04N 21/81; H04N 21/439

(52) U.S. Cl. CPC H04N 21/8113; H04N 21/4394

(57) ABSTRACT

The present disclosure relates to a transition position determination method and apparatus, and a medium and an electronic device, which belong to the technical field of electronics, and by means of which an appropriate transition position can be adaptively determined. The transition position determination method includes: segmenting background music of a video to be edited, so as to obtain music slices; extracting sound features of the music slices; and on the basis of the sound features, determining a transition position of the video to be edited.

### CROSS-REFERENCE TO RELATED APPLICATIONS

The present application claims the priority to the Chinese patent application No. 202310553345.9 entitled “TRANSITION POSITION DETERMINATION METHOD AND APPARATUS, AND MEDIUM AND ELECTRONIC DEVICE” filed on May 16, 2023, the disclosure of which is incorporated herein by reference in its entirety.

### TECHNICAL FIELD

The present disclosure relates to the technical field of electronics, and specifically to a transition position determination method and apparatus, and medium and electronic device.

### BACKGROUND

Video editing refers to forming a desired video by combining background music, video materials, special effects, subtitles, transitions, and other contents. However, there is currently no technique that is capable of adaptively determining an appropriate transition position.

### SUMMARY

The “summary” is provided to introduce concepts in a simplified form, which will be described in detail in the following “DETAILED DESCRIPTION”. The “SUMMARY” is not intended to identify key features or essential features of the claimed technical solutions, nor is it intended to limit the scope of the claimed technical solutions.

In a first aspect, the present disclosure provides a transition position determination method, including: segmenting background music of a to-be-edited video to obtain music slices; extracting sound features of the music slices; and determining a transition position of the to-be-edited video on the basis of the sound features.

In a second aspect, the present disclosure provides a transition position determination apparatus, including: a segmentation module configured to segment background music of a to-be-edited video to obtain music slices; an extraction module configured to extract sound features of the music slices; and a transition determination module configured to determine a transition position of the to-be-edited video on the basis of the sound features.

In a third aspect, the present disclosure provides a computer-readable medium having thereon stored a computer program which, when executed by a processing device, implements the method in the first aspect of the present disclosure.

In a fourth aspect, the present disclosure provides an electronic device, including: a storage device having a computer program stored thereon; and a processing device configured to execute the computer program in the storage device to implement the method in the first aspect of the present disclosure.

In a fifth aspect, the present disclosure provides a computer program product, including a computer program which, when executed by a processing device, implements the method in the first aspect of the present disclosure.

In a sixth aspect, the present disclosure provides a computer program which, when executed by a processing device, implements the method in the first aspect of the present disclosure.

Other features of the present disclosure will be described in detail in the following “detailed description”.

### BRIEF DESCRIPTION OF THE DRAWINGS

The above and other features, advantages, and aspects of embodiments of the present disclosure will become more apparent by combining the accompanying drawings and referring to the following detailed description. Throughout the drawings, the same or similar reference numbers refer to the same or similar elements. It should be understood that the drawings are schematic and that parts and elements are not necessarily drawn to scale. In the drawings:

FIG. 1 is a flow diagram of a transition position determination method according to an embodiment of the present disclosure.

FIG. 2 is another flow diagram of a transition position determination method according to an embodiment of the present disclosure.

FIG. 3 is a flow diagram of training a multilayer perception model according to an embodiment of the present disclosure.

FIG. 4 is a schematic block diagram of a transition position determination apparatus according to an embodiment of the present disclosure.

FIG. 5 illustrates a schematic structural diagram of an electronic device suitable for implementing an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, which are provided for a more complete and thorough understanding of the present disclosure rather. It should be understood that the drawings and embodiments of the present disclosure are for exemplary purposes only and are not intended to limit the scope of protection of the present disclosure.

It should be understood that the various steps recited in method embodiments of the present disclosure may be performed in a different order, and/or performed in parallel. Moreover, the method embodiments may include additional steps and/or omit performing the illustrated steps. The scope of the present disclosure is not limited in this respect.

The term “including” and variations thereof used herein are intended to be open-ended, i.e., “including but not limited to”. The term “based on” is “at least partially based on”. The term “one embodiment” means “at least one embodiment”; the term “another embodiment” means “at least one other embodiment”; and the term “some embodiments” means “at least some embodiments”. Relevant definitions for other terms will be given in the following description.

It should be noted that the notions such as “first” and “second” mentioned in the present disclosure are only used for distinguishing different devices, modules or units, and are not used for limiting the order or interdependence of the functions performed by the devices, modules or units.

It should be noted that the modifications of “a” and “a plurality of” in the present disclosure are intended to be illustrative rather than limiting, and that those skilled in the art should appreciate that they should be understood as “one or more” unless otherwise explicitly stated in the context.

The names of messages or information exchanged between a plurality of devices in the embodiments of the present disclosure are for illustrative purposes only, and are not intended to limit the scope of the messages or information.

It can be understood that, before the technical solutions disclosed in the embodiments of the present disclosure are used, a type, use range, use scenario, etc. of personal information involved in the present disclosure should be notified to a user and authorized from the user in a proper manner according to related laws and regulations.

For example, in response to receiving an active request of a user, a prompt message is sent to the user to explicitly prompt the user that an operation he requests to be performed would require acquisition and use of personal information of the user. Thus, the user can, according to the prompt message, autonomously select whether to provide personal information to software or hardware such as an electronic device, an application, a server, or a storage medium that performs the operations of the technical solution of the present disclosure.

As an optional but non-limiting implementation, in response to receiving an active request of a user, a prompt message may be sent to the user, for example, in a manner of a pop-up window, where the prompt message may be presented in a manner of text. In addition, in the pop-up window, a selection control provided for the user to select “Agree” or “Disagree” on providing the personal information to an electronic device can be carried.

It can be understood that the above processes of notification and authorization from the user are only illustrative and not intended to limit the implementation of the present disclosure, and other manners in which the related laws and regulations are satisfied can also be applied to the implementation of the present disclosure.

Meanwhile, it can be understood that data (including but not limited to the data itself, acquisition or use of the data) involved in this technical solution should comply with requirements of the corresponding laws and regulations and related provisions.

With the technical solution of the present disclosure, background music of a to-be-edited video is first segmented to obtain music slices, then sound features of the music slices are extracted, and then a transition position of the to-be-edited video is determined on the basis of the sound features, so that an appropriate transition position can be adaptively determined on the basis of the background music of the to-be-edited video, reducing the labor and burden of a video creator.

Before the embodiments according to the present disclosure are described in detail, meanings of terms involved in the present disclosure are explained first.

Background music refers to music information in a video, which may be a song, dubbing, or the like.

A time unit refers to one basic time slice, e.g. 0.1 seconds. A piece of audio with a duration of 10 seconds can be segmented into 100 continuous music slices in time units of 0.1 seconds. There is no overlap between the music slices.

Sampling frequency: a sound, which is a continuous signal, requires quantization before it can be stored. The quantization involves two aspects, where one is quantization of an amplitude of the sound signal and the other is quantization of a time of the sound signal. The sampling frequency here refers to the quantization of the time of the sound signal, i.e., how many samples are collected per second. For example, a sampling frequency is 44100, meaning that for an audio signal of one second, 44100 samples are collected at equal intervals.

A transition refers to a transitional effect for connecting two pieces of video materials.

A timestamp refers to a time point at which a time occurs.

Local context: for a time window K, a local context refers to a section with a length of (2K+1), which is formed by current music slice, K music slices before the current music slice, and K music slices after the current music slice.

A local feature refers to a feature formed after the local context is comprehensively considered, a range of a receptive field being (2K+1) time units.

A global feature refers to a feature formed after the whole background music is comprehensively considered, a range of a receptive field being equal to a length of the whole background music.

A transition position refers to an appropriate transition position determined according to input background music. These transition positions usually have a strong correlation with a melody of the background music, for example, a transition position can appear at a time point when a rhythm of the background music changes, forming a beat synchronization video.

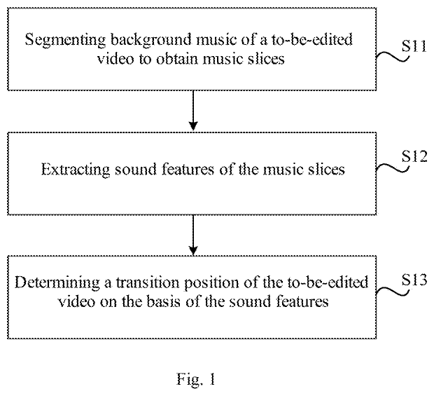

FIG. 1 is a flow diagram of a transition position determination method according to an embodiment of the present disclosure. As shown in FIG. 1, the transition position determination method includes the following steps S11 to S13.

In step S11, background music of a to-be-edited video is segmented to obtain music slices.

The to-be-edited video refers to a video to be edited.

The background music of the to-be-edited video refers to a song, dubbing, or the like selected by a user and expected as the background music of the to-be-edited video.

In some embodiments, the background music of the to-be-edited video may be segmented in units of a first time unit to obtain music slices. The segmented music slices are continuous and there is no overlap between the music slices. A value of the first time unit may be set according to actual situations, for example, 0.1 seconds or other values. Taking an example that a duration of background music of a to-be-edited video is 10 seconds, and a size of a first time unit is 0.1 seconds, 100 continuous music slices can be obtained by segmentation, and there is no overlap between the music slices. Each music slice obtained by the segmentation is essentially a shorter audio signal.

In addition, if a time length of a last music slice in the segmented music slices is less than the first time unit, the time length of the last music slice may be complemented to the first time unit by using complementing information. For example, if a duration of background music of a to-be-edited video is 10.05 seconds, and a size of a first time unit is 0.1 seconds, a duration of a last music slice segmented is 0.05 seconds, which is less than the size of the first time unit, i.e., 0.1 seconds, in this case, the time length of the last music slice can be complemented by using complementing information to 0.1 seconds (i.e., the size of the first time unit). The complementing information may be set as needed, for example, 0.

In step S12, sound features of the music slice is extracted.

In some embodiments, taking the music slice as an object, a cepstral coefficient feature (e.g., Mel frequency cepstral coefficient (MFCC) feature) and an energy feature may be extracted from the music slice, and a sound signal of the music slice is mapped to extract a depth learning feature of the music slice, for example, the sound signal of the music slice is mapped by using a linear mapping layer to extract an adaptive depth-learning-based feature of the music slice. That is, for each music slice, the above three features are extracted therefrom, respectively. The cepstral coefficient feature reflects frequency characteristics of a sound in the music slice, and the energy feature reflects energy characteristics of the sound in the music slice, the two features containing some representative information of the sound. The deep learning feature reflects other features of the sound in the music slice than the cepstral coefficient feature and the energy feature, the other features being obtained by means of autonomous learning such as deep learning.

In addition, the cepstral coefficient feature, energy feature and deep learning feature of each of the music slices may be spliced to obtain respective sound feature of each of the music slices. The splicing operation may be end-to-end splicing of the cepstral coefficient feature, energy feature, and deep learning feature. For example, a cepstral coefficient feature, energy feature and deep learning feature of a first music slice are spliced to obtain a sound feature of the first music slice; a cepstral coefficient feature, energy feature and deep learning feature of a second music slice are spliced to obtain a sound feature of the second music slice; and so on, respective sound features of all the music slices are obtained.

In step S13, a transition position of the to-be-edited video is determined on the basis of the sound features.

In some embodiments, the transition position of the to-be-edited video may be determined by a multilayer perceptron (MLP) on the basis of the sound features.

In some embodiments, determining the transition position of the to-be-edited video on the basis of the sound features may be implemented as follows.

Firstly, the sound feature of the music slice is processed on the basis of context of the music slice to obtain a local feature of the music slice. For example, it is able to first determine similarities between the sound feature to be processed and sound features of music slices falling within a first time window before and after the music slice corresponding to the sound feature to be processed, and then process the sound feature to be processed on the basis of the similarities to obtain the local feature of the music slice. In this way, adjustment will be made to each sound feature on the basis of the context of each sound feature, and the adjustment is very fast in speed. This adjustment may also be referred to as local attention adjustment.

For example, a duration of background music of a to-be-edited video is 10 seconds, a size of a first time unit is 0.1 seconds, 100 music slices are obtained by segmentation, and by performing sound feature extraction on the 100 music slices respectively, 100 sound features can be obtained, denoted by {f1, f2, f3, . . . , f100}. Assuming that a width of a first time window is 5, for the sound feature f6 of the 6th music slice, its context has 11 sound features in total, namely {f1, f2, f3, f4, f5, f6, f7, f8, f9, f10, f11}, that is, there are respective 5 sound features before and after the sound feature f6. Then, a local feature of the 6th music slice can be obtained by: calculating a similarity between the sound feature f6 and each of its context features (i.e. the sound features f1, f2, f3, f4, f5, f7, f8, f9, f10, f11), for example, a1=s(f1, f6), a2=s(f2, f6), . . . , a11=s(f11, f6), where s represents similarity calculation; it is worth noting that a6=1, because a similarity between oneself and oneself is 1; after the calculation of all the similarities is completed, by weighted summation, a new sound feature f6 is obtained, that is, f6new =(a1f1+a2f2+a3f3 . . . +a11f11)/(a1+a2+a3 . . . +a11), where f6_{new} is the local feature of the 6th music slice.

Then, attention processing is performed on the local feature of the music slice to obtain a global feature of the music slice. This is actually a global attention, i.e. a range of a receptive field is the whole background music.

For example, attention processing can be performed on the local feature of the music slice by using a self-attention mechanism with linear complexity (also called LinFormer). By the self-attention mechanism with linear complexity, calculation complexity can be optimized to O(N), that is, a calculation duration and space complexity can be enabled to be in a linear correlation relationship with the duration of the background music.

Then, the transition position of the to-be-edited video is determined on the basis of the multilayer perception information of the global feature of the music slice. For example, it is able to first correct (e.g., train) a multilayer perception model on the basis of sample music with transition labels and a preset loss function, then input the global feature of the music slice into the multilayer perception model to obtain multilayer perception information, and then determine the transition position of the to-be-edited video on the basis of the multilayer perception information.

Since a range of a receptive field of the local feature of the music slice is (2×first time window+1) first time units, and a range of a receptive field of the global feature of the music slice is the whole background music, when the transition position of the to-be-edited video is determined, both the situations of respective vicinities of the music slices (which can be considered as seeing sections before and after the music slice to determine whether at the music slice here is a most appropriate beat synchronization position) and the situations of the whole background music (which can be considered as seeing a beat synchronization distribution/style of the whole background music to determine whether there is a need of a beat synchronization at the music slice here) are considered, which ensures that an appropriate transition position can be determined, so that the final effect and content transition of the video are smoother and more reasonable, and a situation that a transition position is not matched with content or background music will not occur, for example, in a piece of background music with super bass, when a transition position is laid in a treble-bass switching position or accent crescendo position or bass crescendo position, there is sensual comfort, but there appears abruptness when a transition position is laid in a part for entering treble or bass.

With the above technical solution, since background music of a to-be-edited video is first segmented to obtain music slices, then sound features of the music slices are extracted, and then a transition position of the to-be-edited video is determined on the basis of the sound features, an appropriate transition position can be adaptively determined on the basis of the background music of the to-be-edited video, reducing the labor and burden of a video creator. The technical solution according to the embodiment of the present disclosure may also be referred to as an audio beat matching (ABM) solution.

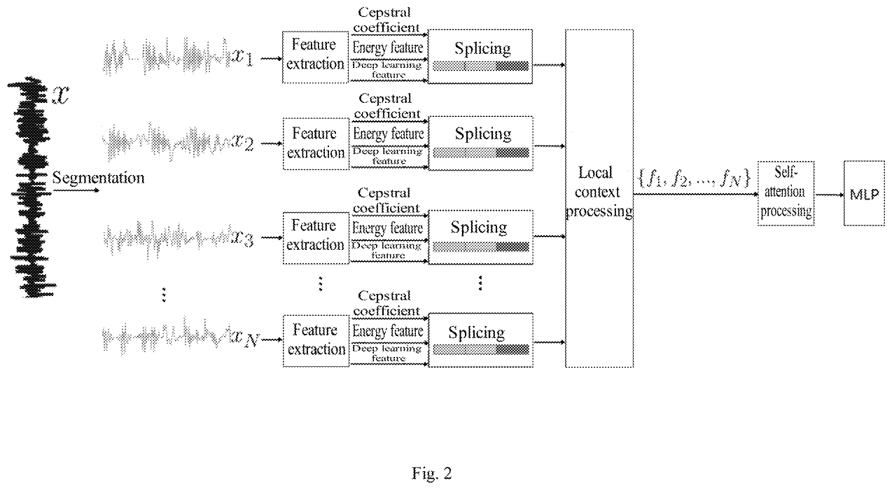

FIG. 2 is another flow diagram of a transition position determination method according to an embodiment of the present disclosure. As shown in FIG. 2, first, background music x of a to-be-edited video is segmented in units of a first time unit, to obtain N music slices x1, X2, X3, . . . XN. The implementation of the segmentation has already been described above and will not be repeated here. Then, feature extraction is performed on each music slice separately to extract a cepstral coefficient feature, an energy feature and a deep learning feature. The implementation of the feature extraction has already been described above and will not be repeated here. Then, the cepstral coefficient feature, energy feature and deep learning feature of each music slice are spliced. And then, local context processing is performed on the spliced feature. The implementation of the local context processing has been described in the above acquisition for the local feature, and will not be repeated here. The local feature obtained by the local context processing, after subjected to self-attention mechanism processing, are processed by a multilayer perceptron, and an appropriate transition position is output by the multilayer perceptron.

With the above technical solution, since background music of a to-be-edited video is first segmented to obtain music slices, then sound features of the music slices are extracted, then local context processing and self-attention mechanism processing are performed on the sound features, and then an appropriate transition position is output by a multilayer perceptron, when the transition position of the to-be-edited video is determined, both the situations of respective vicinities of the music slices (which can be considered as seeing the sections before and after the music slice to determine whether at the music slice here is a most appropriate beat synchronization position) and the situations of the whole background music (which can be considered as seeing a beat synchronization distribution/style of the whole background music to determine whether there is a need of a beat synchronization at the music slice here) are considered, which ensures that an appropriate transition position can be determined, so that the final effect and content transition of the video are smoother and more reasonable, and a situation that a transition position is not matched with content or background music will not occur.

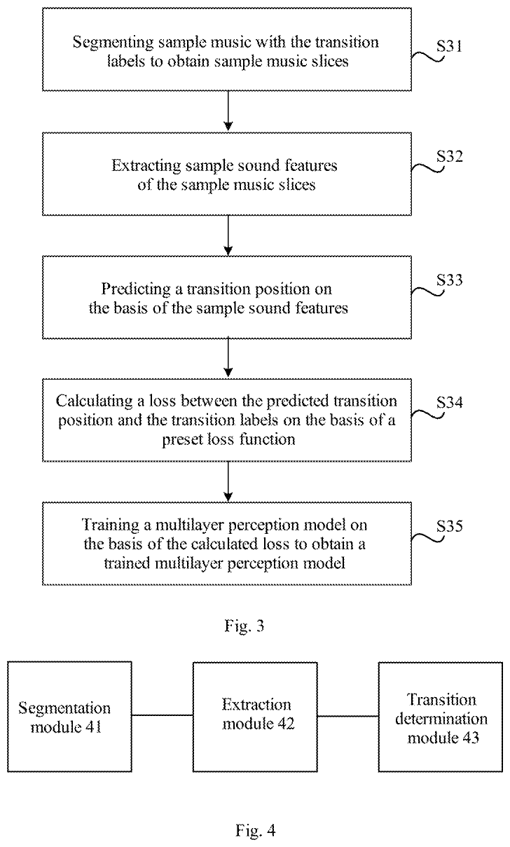

FIG. 3 is a flow diagram of training a multilayer perception model according to an embodiment of the present disclosure.

As shown in FIG. 3, firstly, in step S31, sample music with transition labels is segmented to obtain sample music slices.

The sample music may be acquired from a sample music dataset. The sample music in the sample music dataset is each labeled with a transition position, that is, each piece of data in the sample music dataset contains an original background music audio file and a corresponding transition position timestamp.

The implementation of the segmentation has been described above and will not be repeated here.

In step S32, sample sound features of the sample music slices are extracted. The implementation of the sound feature extraction has been described above, and will not be repeated here.

In step S33, a transition position is predicted on the basis of the sample sound features.

For example, it is possible to perform local context processing and self-attention mechanism processing on the sample sound features, and then predict a transition position on the basis of the processed features. The local context processing and the attention mechanism processing have been described in detail above, and will not be repeated here.

In step S34, a loss between the predicted transition position and the transition labels is calculated on the basis of a preset loss function.

In constructing the preset loss function, two main issues are considered:

(1) How to balance positive and negative samples. The number of transitions in a video, i.e. the number of positive samples, is very small. For example, a 10-second video may contain 3 transitions, and if background music of the video is segmented into 100 segments by a time unit of 0.1 seconds, in the 100 segments, there are 3 segments containing a start time point of the transition, which are positive samples, while the remaining 97 segments all are negative samples. Such imbalance will severely affect the performance of the multilayer perception model.

(2) How to measure an importance level of each label position. For example, a transition position is labeled with 1, a non-transition position is labeled with 0, and one data label containing 6 time units may be [1,0,0,0,0,0]. When the multilayer perception model predicts the transition position, the output of [0,1,0,0,0,0] is obviously much better than the output of [0,0,0,0,0,1], but such a difference cannot be measured by a traditional cross entropy loss. Moreover, the closer the position is to the transition label 1, the more important it is, and it should be predicted correctly; and constraints on a position away from the transition label 1 can be reduced accordingly.

To solve the above two issues, calculating the loss between the predicted transition position and the transition labels on the basis of the preset loss function can implemented as follows.

First, an influence of a transition label belonging to the positive sample is calculated. The influence range of the transition label belonging to the positive sample may be in the form of Gaussian distribution. In addition, to ensure certainty of a value of the influence of the transition label, it may be normalized to ensure that the value of the influence of the transition label is limited to between 0 and 1.

Then, an importance level of positions of the transition labels is calculated on the basis of the influence of the transition label and values of the transition labels. If the transition label is a positive sample, the value of the transition label is 1, and if the transition label is a negative sample, the value of the transition label is 0, that is, only the position with the label of 1 will generate the influence.

Then, the loss between the predicted transition position and the transition labels is calculated on the basis of the predicted transition position, the transition labels, and the importance level of the positions of the transition labels. In addition, in order to balance the positive and negative samples, a window width of the Gaussian distribution may be estimated according to the sample music dataset, so as to make a sum of label weights of the positive samples approximately equal to a sum of label weights of the negative samples when the loss is calculated.

In step S35, a multilayer perception model is trained on the basis of the calculated loss, to obtain a trained multilayer perception model.

With the above technical solution, training of the multilayer perception model can be implemented.

FIG. 4 is a schematic block diagram of a transition position determination apparatus according to an embodiment of the present disclosure. As shown in FIG. 4, the transition position determination apparatus includes: a segmentation module 41 configured to segment background music of a to-be-edited video to obtain music slices; an extraction module 42 configured to extract sound features of the music slices; and a transition determination module 43 configured to determine a transition position of the to-be-edited video on the basis of the sound features.

With the above technical solution, since background music of a to-be-edited video is first segmented to obtain music slices, then sound features of the music slices are extracted, and then a transition position of the to-be-edited video is determined on the basis of the sound features, an appropriate transition position can be adaptively determined on the basis of the background music of the to-be-edited video, reducing the labor and burden of a video creator.

Optionally, segmenting, by the segmentation module 41, the background music of the to-be-edited video includes: segmenting, in units of a first time unit, the background music of the to-be-edited video to obtain the music slices; and complementing, if a time length of a last music slice in the music slices is less than the first time unit, the time length of the last music slice to the first time unit by using complementing information.

Optionally, extracting, by the extraction module 42, the sound features of the music slices includes: extracting a cepstral coefficient feature and an energy feature from the music slice, and mapping a sound signal of the music slice to extract a deep learning feature of the music slice.

Optionally, determining, by the transition determination module 43, the transition position of the to-be-edited video on the basis of the sound features includes: processing the sound feature of the music slice on the basis of context of the music slice to obtain a local feature of the music slice; performing attention processing on the local feature to obtain a global feature of the music slice; and determining the transition position of the to-be-edited video on the basis of multilayer perception information of the global feature.

Optionally, processing, by the transition determination module 43, the sound feature of the music slice on the basis of the context of the music slice to obtain the local feature of the music slice includes: determining similarities between the sound feature to be processed and sound features of music slices falling within a first time window before and after the music slice corresponding to the sound feature to be processed; and processing the sound feature to be processed on the basis of the similarities to obtain the local feature of the music slice.

Optionally, determining, by the transition determination module 43, the transition position of the to-be-edited video on the basis of the multilayer perception information of the global feature includes: correcting a multilayer perception model on the basis of sample music with transition labels and a preset loss function; inputting the global feature into the multilayer perception model to obtain the multilayer perception information; and determining the transition position of the to-be-edited video on the basis of the multilayer perception information.

Optionally, correcting the multilayer perception model on the basis of the sample music with transition labels and the preset loss function includes: segmenting the sample music with the transition labels to obtain sample music slices; extracting sample sound features of the sample music slices; predicting a transition position on the basis of the sample sound features; calculating a loss between the predicted transition position and the transition labels on the basis of the preset loss function; and correcting the multilayer perception model on the basis of the calculated loss.

An embodiment of the present disclosure further provides a computer-readable medium having thereon stored a computer program which, when executed by a processing device, implements any of the methods in the present disclosure.

An embodiment of the present disclosure further provides an electronic device, including: a storage device having a computer program stored thereon; and a processing device configured to execute the computer program in the storage device, to implement any of the methods in the present disclosure.

An embodiment of the present disclosure further provides a computer program product, including a computer program which, when executed by a processing device, implements any of the methods in the present disclosure.

An embodiment of the present disclosure further provides a computer program which, when executed by a processing device, implements any of the methods in the present disclosure.

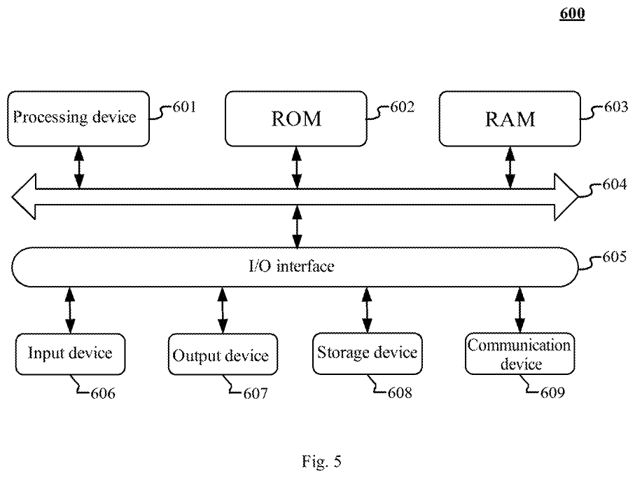

Referring to FIG. 5 below, it illustrates a schematic structural diagram of an electronic device 600 suitable for implementing an embodiment of the present disclosure. The terminal device in the embodiment of the present disclosure may include, but is not limited to, a mobile terminal such as a mobile phone, a laptop computer, a digital broadcast receiver, a PDA (Personal Digital Assistant), a PAD (tablet computer), a PMP (Portable Multimedia Player), and a vehicle-mounted terminal (e.g., a vehicle-mounted navigation terminal), and a fixed terminal such as a digital TV and a desktop computer. The electronic device shown in FIG. 5 is only an example, and should not bring any limitation to the functions and the scope of use of the embodiment of the present disclosure.

As shown in FIG. 5, the electronic device 600 may include a processing device (e.g., central processing unit, graphics processing unit, etc.) 601, which may perform various appropriate actions and processes according to a program stored in a read-only memory (ROM) 602 or a program loaded from a storage device 608 into a random access memory (RAM) 603. In the RAM 603, various programs and data required for the operation of the electronic device 600 are also stored. The processing device 601, the ROM 602, and the RAM 603 are connected to each other via a bus 604. An input/output (I/O) interface 605 is also connected to the bus 604.

Generally, the following devices may be connected to the I/O interface 605: an input device 606 including, for example, a touch screen, touch pad, keyboard, mouse, camera, microphone, accelerometer, gyroscope, etc.; an output device 607 including, for example, a liquid crystal display(LCD), speaker, vibrator, etc.; the storage device 608 including, for example, a magnetic tape, hard disk, etc.; and a communication device 609. The communication device 609 may allow the electronic device 600 to communicate with other devices wirelessly or by wire to exchange data. While FIG. 5 illustrates the electronic device 600 having the various devices, it should be understood that there is no requirement that all the illustrated devices are implemented or provided. More or fewer devices may be alternatively implemented or provided.

In particular, the processes described above with reference to the flow diagrams may be implemented as a computer software program according to an embodiment of the present disclosure. For example, an embodiment of the present disclosure includes a computer program product, which includes a computer program carried on a non-transitory computer-readable medium, the computer program containing program code for performing the method illustrated by the flow diagrams. In such an embodiment, the computer program may be downloaded and installed from a network via the communication device 609, or installed from the storage device 608, or installed from the ROM 602. The computer program, when executed by the processing device 601, performs the above functions defined in the method of the embodiments of the present disclosure.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program which can be used by or in conjunction with an instruction execution system, apparatus, or device. However, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, where the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

In some embodiments, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has thereon carried one or more programs which, when executed by the electronic device, cause the electronic device to: segment background music of a to-be-edited video to obtain music slices; extract sound features of the music slices; and determine a transition position of the to-be-edited video on the basis of the sound features.

Computer program code for performing the operation of the present disclosure may be written in one or more programming languages or a combination thereof, where the above programming language includes but is not limited to an object-oriented programming language such as Java, Smalltalk, and C++, and also includes a conventional procedural programming language, such as a “C” language or a similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved modules described in the embodiments of the present disclosure may be implemented by software or hardware. The name of the module does not, in some cases, constitute a limitation on the module itself, for example, the extraction module may also be described as “a module configured to extract sounds feature of the music slices”.

The functions described above herein may be executed at least partially by one or more hardware logic components. For example, without limitation, a hardware logic component of an exemplary type that may be used includes: a field programmable gate array (FPGA), an application specific integrated circuit (ASIC), an application specific standard product (ASSP), a system on chip (SOC), a complex programmable logic device (CPLD), and the like.

In the context of this disclosure, a machine-readable medium may be a tangible medium, which can contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, example 1 provides a transition position determination method, including: segmenting background music of a to-be-edited video to obtain music slices; extracting sound features of the music slices; and determining a transition position of the to-be-edited video on the basis of the sound features.

According to one or more embodiments of the present disclosure, example 2 provides the method of example 1, where segmenting the background music of the to-be-edited video includes: segmenting, in units of a first time unit, the background music of the to-be-edited video to obtain the music slices; and complementing, if a time length of a last music slice in the music slices is less than the first time unit, the time length of the last music slice to the first time unit by using complementing information.

According to one or more embodiments of the present disclosure, example 3 provides the method of example 1 or 2, where extracting the sound features of the music slices includes: extracting a cepstral coefficient feature and an energy feature from the music slice; and mapping a sound signal of the music slice to extract a deep learning feature of the music slice.

According to one or more embodiments of the present disclosure, example 4 provides the method of any of examples 1 to 3, where determining the transition position of the to-be-edited video on the basis of the sound features includes: processing the sound feature of the music slice on the basis of context of the music slice to obtain a local feature of the music slice; performing attention processing on the local feature to obtain a global feature of the music slice; and determining the transition position of the to-be-edited video on the basis of multilayer perception information of the global feature.

According to one or more embodiments of the present disclosure, example 5 provides the method of example 4, where processing the sound feature of the music slice on the basis of the context of the music slice to obtain the local feature of the music slice includes: determining similarities between the sound feature to be processed and sound features of music slices falling within a first time window before and after the music slice corresponding to the sound feature to be processed; and processing the sound feature to be processed on the basis of the similarities to obtain the local feature of the music slice.

According to one or more embodiments of the present disclosure, example 6 provides the method of example 4, where determining the transition position of the to-be-edited video on the basis of the multilayer perception information of the global feature includes: correcting a multilayer perception model on the basis of sample music with transition labels and a preset loss function; inputting the global feature into the multilayer perception model to obtain the multilayer perception information; and determining the transition position of the to-be-edited video on the basis of the multilayer perception information.

According to one or more embodiments of the present disclosure, example 7 provides the method of example 6, where correcting the multilayer perception model on the basis of the sample music with the transition labels and the preset loss function includes: segmenting the sample music with the transition labels to obtain sample music slices; extracting sample sound features of the sample music slices; predicting a transition position on the basis of the sample sound features; calculating a loss between the predicted transition position and the transition labels on the basis of the preset loss function; and correcting the multilayer perception model on the basis of the calculated loss.

According to one or more embodiments of the present disclosure, example 8 provides the method of example 7, where calculating the loss between the predicted transition position and the transition labels on the basis of the preset loss function includes: c calculating an influence of a transition label belonging to a positive sample; calculating an importance level of positions of the transition labels on the basis of the influence and values of the transition labels; and calculating the loss between the predicted transition position and the transition labels on the basis of the predicted transition position, the transition labels, and the importance level of the positions of the transition labels.

According to one or more embodiments of the present disclosure, example 9 provides a transition position determination apparatus, including: a segmentation module configured to segment background music of a to-be-edited video to obtain music slices; an extraction module configured to extract sound features of the music slices; and a transition determination module configured to determine a transition position of the to-be-edited video on the basis of the sound features.

According to one or more embodiments of the present disclosure, example 10 provides a computer-readable medium having thereon stored a computer program which, when executed by a processing device, implements the method according to any of examples 1-8.

According to one or more embodiments of the present disclosure, example 11 provides an electronic device, including: a storage device having a computer program stored thereon; a processing device configured to execute the computer program in the storage device to implement the method according to any of examples 1-8.

According to one or more embodiments of the present disclosure, example 12 provides a computer program product, including a computer program which, when executed by a processing device, implements the method according to any of examples 1-8.

According to one or more embodiments of the present disclosure, example 13 provides a computer program which, when executed by a processing device, implements the method according to any of examples 1-8.

The foregoing description is only illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing may be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms in which the claims are implemented. With regard to the apparatus in the above embodiments, the specific manner in which each module therein performs the operation has been described in detail in the embodiments related to the method, and will not be elaborated here.

1. A transition position determination method, comprising:
segmenting background music of a to-be-edited video to obtain music slices;
extracting sound features of the music slices; and
determining a transition position of the to-be-edited video on the basis of the sound features.

2. The method according to claim 1, wherein segmenting the background music of the to-be-edited video comprises:
segmenting, in units of a first time unit, the background music of the to-be-edited video to obtain the music slices; and
complementing, if a time length of a last music slice in the music slices is less than the first time unit, the time length of the last music slice to the first time unit by using complementing information.

3. The method according to claim 1, wherein extracting the sound features of the music slices comprises:
extracting a cepstral coefficient feature and an energy feature from the music slice; and
mapping a sound signal of the music slice to extract a deep learning feature of the music slice.

4. The method according to claim 1, wherein determining the transition position of the to-be-edited video on the basis of the sound features comprises:
processing the sound feature of the music slice on the basis of context of the music slice to obtain a local feature of the music slice;
performing attention processing on the local feature to obtain a global feature of the music slice; and
determining the transition position of the to-be-edited video on the basis of multilayer perception information of the global feature.

5. The method according to claim 4, wherein processing the sound feature of the music slice on the basis of the context of the music slice to obtain the local feature of the music slice comprises:
determining similarities between the sound feature to be processed and sound features of music slices falling within a first time window before and after the music slice corresponding to the sound feature to be processed; and
processing the sound feature to be processed on the basis of the similarities to obtain the local feature of the music slice.

6. The method according to claim 4, wherein determining the transition position of the to-be-edited video on the basis of the multilayer perception information of the global feature comprises:
correcting a multilayer perception model on the basis of sample music with transition labels and a preset loss function;
inputting the global feature into the multilayer perception model to obtain the multilayer perception information; and
determining the transition position of the to-be-edited video on the basis of the multilayer perception information.

7. The method according to claim 6, wherein correcting the multilayer perception model on the basis of the sample music with the transition labels and the preset loss function comprises:
segmenting the sample music with the transition labels to obtain sample music slices;
extracting sample sound features of the sample music slices;
predicting a transition position on the basis of the sample sound features;
calculating a loss between the predicted transition position and the transition labels on the basis of the preset loss function; and
correcting the multilayer perception model on the basis of the calculated loss.

8. The method according to claim 7, wherein calculating the loss between the predicted transition position and the transition labels on the basis of the preset loss function comprises:
calculating an influence of a transition label belonging to a positive sample;
calculating an importance level of positions of the transition labels on the basis of the influence and values of the transition labels; and
calculating the loss between the predicted transition position and the transition labels on the basis of the predicted transition position, the transition labels, and the importance level of the positions of the transition labels.

9. (canceled)

10. A non-transitory computer-readable storage medium having thereon stored a computer program which, when executed by a processing device, implements the following transition position determination operations:
segmenting background music of a to-be-edited video to obtain music slices;
extracting sound features of the music slices; and
determining a transition position of the to-be-edited video on the basis of the sound features.

11. An electronic device, comprising:
a storage device having a computer program stored thereon;
a processing device configured to execute the computer program in the storage device to implement the following transition position determination operations:
segmenting background music of a to-be-edited video to obtain music slices;
extracting sound features of the music slices; and
determining a transition position of the to-be-edited video on the basis of the sound features.

12-13. (canceled)

14. The non-transitory computer-readable storage medium according to claim 10, wherein segmenting the background music of the to-be-edited video comprises:
segmenting, in units of a first time unit, the background music of the to-be-edited video to obtain the music slices; and
complementing, if a time length of a last music slice in the music slices is less than the first time unit, the time length of the last music slice to the first time unit by using complementing information.

15. The non-transitory computer-readable storage medium according to claim 10, wherein extracting the sound features of the music slices comprises:
extracting a cepstral coefficient feature and an energy feature from the music slice; and
mapping a sound signal of the music slice to extract a deep learning feature of the music slice.

16. The non-transitory computer-readable storage medium according to claim 10, wherein determining the transition position of the to-be-edited video on the basis of the sound features comprises:
processing the sound feature of the music slice on the basis of context of the music slice to obtain a local feature of the music slice;
performing attention processing on the local feature to obtain a global feature of the music slice; and
determining the transition position of the to-be-edited video on the basis of multilayer perception information of the global feature.

17. The non-transitory computer-readable storage medium according to claim 16, wherein processing the sound feature of the music slice on the basis of the context of the music slice to obtain the local feature of the music slice comprises:
determining similarities between the sound feature to be processed and sound features of music slices falling within a first time window before and after the music slice corresponding to the sound feature to be processed; and
processing the sound feature to be processed on the basis of the similarities to obtain the local feature of the music slice.

18. The non-transitory computer-readable storage medium according to claim 16, wherein determining the transition position of the to-be-edited video on the basis of the multilayer perception information of the global feature comprises:
correcting a multilayer perception model on the basis of sample music with transition labels and a preset loss function;
inputting the global feature into the multilayer perception model to obtain the multilayer perception information; and
determining the transition position of the to-be-edited video on the basis of the multilayer perception information.

19. The electronic device according to claim 11, wherein segmenting the background music of the to-be-edited video comprises:
segmenting, in units of a first time unit, the background music of the to-be-edited video to obtain the music slices; and
complementing, if a time length of a last music slice in the music slices is less than the first time unit, the time length of the last music slice to the first time unit by using complementing information.

20. The electronic device according to claim 11, wherein extracting the sound features of the music slices comprises:
extracting a cepstral coefficient feature and an energy feature from the music slice; and
mapping a sound signal of the music slice to extract a deep learning feature of the music slice.

21. The electronic device according to claim 11, wherein determining the transition position of the to-be-edited video on the basis of the sound features comprises:
processing the sound feature of the music slice on the basis of context of the music slice to obtain a local feature of the music slice;
performing attention processing on the local feature to obtain a global feature of the music slice; and
determining the transition position of the to-be-edited video on the basis of multilayer perception information of the global feature.

22. The electronic device according to claim 21, wherein processing the sound feature of the music slice on the basis of the context of the music slice to obtain the local feature of the music slice comprises:
determining similarities between the sound feature to be processed and sound features of music slices falling within a first time window before and after the music slice corresponding to the sound feature to be processed; and
processing the sound feature to be processed on the basis of the similarities to obtain the local feature of the music slice.

23. The electronic device according to claim 21, wherein determining the transition position of the to-be-edited video on the basis of the multilayer perception information of the global feature comprises:
correcting a multilayer perception model on the basis of sample music with transition labels and a preset loss function;
inputting the global feature into the multilayer perception model to obtain the multilayer perception information; and
determining the transition position of the to-be-edited video on the basis of the multilayer perception information.
